(19) United States
(12) Patent Application Publication
(10) Pub. No.: US 2022/0308196 A1
(43) Pub. Date: Sep. 29, 2022

(54) METHODS AND APPARATUS FOR LOW POWER MOTION DETECTION

(71) Applicant: Texas Instruments Incorporated, Dallas, TX (US)

(72) Inventors: Sandeep Rao, Bangalore (IN); Aleksandar Purkovic, Darnestown, MD (US)

(21) Appl. No.: 17/388,954

(22) Filed: Jul. 29, 2021

(30) Foreign Application Priority Data
Mar. 29, 2021 (IN) 202141013900

(51) Int. Cl. G01S 13/56; G01S 13/34; G01S 7/41

(52) U.S. Cl. CPC G01S 13/56; G01S 13/343; G01S 7/415

(57) ABSTRACT

Methods and apparatus are disclosed low power motion detection by a radar apparatus. One example radar apparatus includes a transmitter to transmit a pattern of chirps. The transmitted pattern includes a first series of chirps transmitted during a first time period and a second series of chirps transmitted during a second time period that begins after passage of a sleep time period from an end of the first time period. The example radar apparatus also includes a receiver to detect returning chirps including reflected portions of the transmitted pattern. The example radar apparatus also includes analog to digital converter (ADC) coupled to the receiver. The ADC is to sample analog signals from the receiver to generate ADC samples for the returning chirps detected by the receiver.

### RELATED APPLICATION

This patent claims priority from Indian Patent Application No. 202141013900 filed on Mar. 29, 2021, the entirety of which is incorporated herein by reference.

### FIELD OF THE DISCLOSURE

This disclosure relates generally to radars and, more particularly, to methods and apparatus for low power motion detection.

### BACKGROUND

Radars are used in a variety of systems for object detection, localization, classification, and/or velocity estimation. For example, a vehicle can be equipped with a radar to detect and monitor nearby vehicles and other obstacles. A frequency modulated continuous wave (FMCW) radar is type of radar that scans a field-of-view (FOV) by transmitting one or more chirps. A chirp is a radio frequency (RF) signal that is modulated, for example, by sweeping through a range of frequencies over a chirp duration. The transmitted chirp (or a portion thereof) may then be scattered by an object and reflected back to the FMCW radar. In general, the reflected chirp is a time-delayed version of the transmitted chirp. Thus, the reflected chirp can be processed to estimate a range (i.e., distance) between the FMCW radar and the object, for example, by using a digital signal processing technique such as a range fast Fourier transform (FFT). The FMCW radar can also be used to estimate a velocity of the object by transmitting a sequence of chirps. If the object is moving, then a sequence of reflected chirps will be received by the FMCW radar after different time delays from respective transmitted chirps, and thus the velocity of the object can be estimated, for example, by using a digital signal processing technique such as a doppler FFT.

### BRIEF DESCRIPTION OF THE DRAWINGS

FIG. 1 illustrates an example computing environment including a radar system constructed in accordance with teachings in this disclosure.

FIG. 2 illustrates an example implementation of the radar system of FIG. 1.

FIG. 3 is a timing diagram of a first example scan pattern representative of a series of chirps evenly distributed across a scan frame transmitted by an example transmitter of FIGS. 1 and 2.

FIG. 4 is a timing diagram of a second example scan pattern representative of two blocks of chirps in a scan frame transmitted by the example transmitter of FIGS. 1 and 2 in an example low power motion detection mode.

FIG. 5 is a timing diagram of a third example scan pattern representative of a series of chirps evenly distributed across a scan frame transmitted by first and second instances of the example transmitter of FIGS. 1 and 2.

FIG. 6 is a timing diagram of a fourth example scan pattern representative of two blocks of chirps transmitted by first and second instances of the example transmitter of FIGS. 1 and 2.

FIG. 7 illustrates a motion detection scenario in which the example radar system of FIGS. 1-2 transitions between a first scan mode and a second scan mode.

FIG. 8 is a block diagram representative of data processing flow in accordance with an example implementation of the example radar systems of FIGS. 1-2.

FIG. 9 illustrates range FFT data obtained using an example signal processor of the example radar system of FIG. 2 in a scenario where the example radar system is scanning a field-of-view.

FIG. 10 illustrates range FFT data obtained using an example signal processor of the example radar system of FIG. 2 in a scenario where the example radar system is scanning an obstruction in the field-of-view.

FIG. 11 illustrates range FFT data obtained using an example signal processor of the example radar system of FIG. 2 in a scenario where the example radar system is scanning a moving object in the field-of-view.

FIG. 12 is a flowchart representative of an example process performed using hardware and/or executable machine readable instructions to implement the example radar system of FIG. 2 or a portion thereof.

FIG. 13 is a block diagram of an example processing platform structured to execute the example processes of FIG. 12 to implement the example radar system of FIGS. 1-2 or portion(s) thereof.

### DETAILED DESCRIPTION

The figures are not to scale. In general, the same reference numbers will be used throughout the drawing(s) and accompanying written description to refer to the same or like parts. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein “substantially real time” refers to occurrence in a near instantaneous manner recognizing there may be real world delays for computing time, transmission, etc. Thus, unless otherwise specified, “substantially parallel” and “substantially real time” refer to real time+/−1 second.

FMCW radars and other chirp radars are advantageous for some applications. For example, building security systems can use a radar sensor as a motion detector to detect and/or monitor presence or motion of objects (e.g., people) in an area-of-interest (e.g., room). In this example, a sensitivity of a motion detection capability of the radar can be scaled by increasing a total active time of chirps (e.g., by increasing a number of chirps) emitted by the radar into a FOV of the radar during each scan frame period. By processing more chirps scanned during a longer scan frame period for instance, a velocity resolution characteristic of the radar can be improved. Increasing the number of chirps in a scan frame may also result in higher associated power and computing costs. In some applications however, power and/or computing resources may be limited. For example, in the context of a building security system or other computing system that uses the radar for motion detection, the radar may be powered by a battery or other limited power source and configured to scan an area-of-interest continuously or intermittently for relatively long periods of time (e.g., hours, days, etc.). Accordingly, some examples disclosed herein enable a radar to operate in a low power motion detection mode that reduces power consumption while also providing sensor characteristics relevant to motion detection (e.g., velocity resolution, etc.).

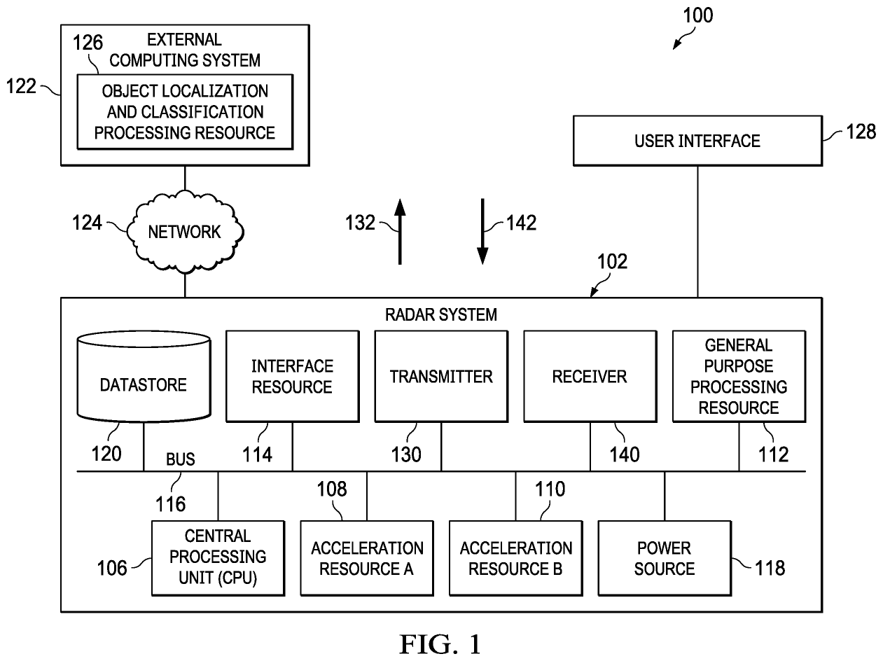

FIG. 1 is an illustration of an example computing environment 100 including an example radar system 102 constructed in accordance with teachings in this disclosure. In the illustrated example of FIG. 1, the example computing environment 100 includes the example radar system 102. The radar system 102 includes an example central processing unit (CPU) 106, a first example acceleration resource (ACCELERATION RESOURCE A) 108, a second example acceleration resource (ACCELERATION RESOURCE B) 110, an example general purpose processing resource 112, an example interface resource 114, an example bus 116, an example power source 118, and an example datastore 120. The computing environment 100 also includes an example external computing system 122, an example network 124, and an example user interface 128. In the illustrated example of FIG. 1, the radar system 102 also includes an example transmitter 130, and an example receiver 140.

In some examples, the radar system 102 is a system-on-a-chip (SoC) device that includes one or more integrated circuits (ICs) (e.g., compact ICs) that incorporate components of a computer or other electronic system in a compact format. For example, the radar system 102 may be implemented with a combination of one or more programmable processors, hardware logic, digital circuitry, analog circuitry, hardware peripherals, and/or interfaces. Additionally or alternatively, the example radar system 102 of FIG. 1 may include memory, input/output (I/O) port(s), and/or secondary storage. In some examples, the radar system 102 includes any combination of the CPU 106, the first acceleration resource 108, the second acceleration resource 110, the general purpose processing resource 112, the interface resource 114, the bus 116, the power source 118, the datastore 120, the transmitter 130, the receiver 140, the memory, the I/O port(s), and/or the secondary storage integrated on a single IC substrate. Additionally or alternatively, in some examples, one or more components of the example radar system 102 illustrated in FIG. 1 (e.g., the example power source 118) are implemented outside the example radar system 102 and are connected to the example radar system 102 similarly to the example user interface 128. In some examples, the radar system 102 includes digital, analog, mixed-signal, radio frequency (RF), or other signal processing functions.

The CPU 106 includes one or more processors that execute machine readable instructions (e.g., application code, etc.). In some examples, the CPU 106 includes one or more cores (e.g., compute cores, processor cores, etc.). The first acceleration resource 108 may include a graphics processing unit (GPU). For example, the first acceleration resource 108 may be a GPU that generates computer graphics, executes general-purpose computing, etc. In some examples, the first acceleration resource 108 may generate graphics for the user interface 128. The second acceleration resource 110 may include an Artificial Intelligence (AI) accelerator. For example, the second acceleration resource 110 may be a vision processing unit to effectuate machine or computer vision computing tasks, object-identification computing tasks, etc. The general purpose processing resource 112 is a programmable processor. For example, the general purpose processing resource 112 may be a CPU, a GPU, etc. Alternatively, one or more of the first acceleration resource 108, the second acceleration resource 110, and/or the general purpose processing resource 112 may be a different type of hardware such as a digital signal processor (DSP), an application specific integrated circuit (ASIC), a programmable logic device (PLD), and/or a field programmable logic device (FPLD) (e.g., a field-programmable gate array (FPGA)).

The interface resource 114 implements and/or is representative of one or more interfaces (e.g., computing interfaces, network interfaces, vehicle network or bus interfaces, industrial protocol network or bus interfaces, etc.). For example, the interface resource 114 may be hardware, software, and/or firmware that implements a communication device (e.g., a communication gateway, a network interface card (NIC), a smart NIC, etc.) such as a transmitter, a receiver, a transceiver, a modem, an industrial protocol gateway, a residential gateway, a wireless access point, and/or a network interface to facilitate exchange of data with external machines (e.g., the external computing system 122 and/or other computing devices of any kind) directly and/or via the network 124. In some examples, the communication is effectuated via a Bluetooth® connection, a controller area network (CAN) bus, an Ethernet connection, a digital subscriber line (DSL) connection, a wireless fidelity (Wi-Fi) connection, a telephone line connection, a coaxial cable system, a satellite system, a line-of-site wireless system, a cellular telephone system, etc. For example, the interface resource 114 may be implemented by any type of interface standard, such as a Bluetooth® interface, a CAN interface, an Ethernet interface, a Wi-Fi interface, a universal serial bus (USB), a near field communication (NFC) interface, and/or a PCI express interface.

The bus 116 corresponds to, is representative of, and/or otherwise includes at least one of a CAN bus, an Inter-Integrated Circuit (I2C) bus, a Serial Peripheral Interface (SPI) bus, a Peripheral Component Interconnect (PCI) bus, a JTAG interface, a data cache, an instruction cache, and/or any other type of data pipeline. Additionally or alternatively, the bus 116 may implement any other type of computing or electrical bus.

In the illustrated example of FIG. 1, the radar system 102 includes the power source 118 to deliver power to resource(s) and/or various components of the radar system 102. In this example, the power source 118 is implemented by one or more batteries (e.g., lithium-ion batteries or any other chargeable battery or power source). For example, the power source 118 may be chargeable using a power adapter or converter (e.g., an alternating current (AC)/direct current (DC) power converter, etc.), a wall outlet (e.g., a 110 Volt (V) AC wall outlet, a 220 V AC wall outlet, etc.), etc. In some examples, the power source 118 may be chargeable by an external system (e.g., the external computing system 122). Alternatively, in other examples, the power source 118 is implemented outside the radar system 102 as an external component coupled the radar system 102.

The radar system 102 includes the datastore 120 to store data, including program instructions, secure data, public data, etc. The datastore 120 may be implemented by a volatile memory (e.g., one or more flip-flops, Synchronous Dynamic Random Access Memory (SDRAM), Dynamic Random Access Memory (DRAM), RAMBUS Dynamic Random Access Memory (RDRAM), etc.) and/or a non-volatile memory (e.g., flash memory). The datastore 120 may additionally or alternatively be implemented by one or more double data rate (DDR) memories, such as DDR, DDR2, DDR3, DDR4, mobile DDR (mDDR), etc. The datastore 120 may additionally or alternatively be implemented by one or more mass storage devices such as hard disk drive(s) (HDD(s)), compact disk (CD) drive(s), digital versatile disk (DVD) drive(s), solid-state disk drive(s), etc. While in the illustrated example the datastore 120 is illustrated as a single datastore, the datastore 120 may alternatively or additionally be implemented by any number and/or type(s) of datastores. Furthermore, the data stored in the datastore 120 may be in any data format such as, for example, binary data, comma delimited data, tab delimited data, structured query language (SQL) structures, etc.

The radar system 102 includes the transmitter 130 to transmit a pattern of chirps 132 (e.g., a pattern of chirp signals, a pattern of radio signals, etc.) into the environment 100. For example, the transmitter 130 includes any combination of interconnected circuitry such as one or more transmit antennas, signal synthesis circuitry (e.g., oscillators, etc.), and/or signal conditioning circuitry (e.g., amplifiers, filters, etc.). In some examples, the transmitter 130 modulates the pattern of chirps 132 based on a scan mode of the radar system 102. In a first example scan mode (e.g., low power mode, idle mode, semi-idle mode, etc.), the transmitter 130 transmits, during a scan frame period, the pattern of chirps as a first block of chirps and a second block of chirps separated by a sleep time period. During the sleep time period, for example, the radar system 102 may temporarily enter a sleep state to reduce power consumption by the CPU 106, the first acceleration resource 108, the second acceleration resource 110, the general purpose processing resource 112, the interface resource 114, the bus 116, the power source 118, the datastore 120, the transmitter 130, and/or the receiver 140. In this way, average power consumption of the radar system 102 when operating in the first example scan mode may be less than when the radar system 102 is operating in a different scan mode (e.g., active scan mode, etc.). In a second example scan mode (e.g., doppler mode, etc.), the transmitter 130 transmits the pattern of chirps as a single block of chirps (e.g., equally spaced in the time domain).

The radar system 102 includes the receiver 140 to receive a returning pattern of radio signals 142 (e.g., a pattern of chirps) reflected and/or scattered back to the radar system 102 from the environment 100. For example, the receiver 140 includes any combination of interconnected circuitry such as one or more receive antennas, mixers, amplifiers, filters, etc.

One or more of the CPU 106, the first acceleration resource 108, the second acceleration resource 110, the general purpose processing resource 112, the interface resource 114, the bus 116, the power source 118, the datastore 120, the transmitter 130, and/or the receiver 140 are in communication with the bus 116.

The radar system 102 is in communication with the external computing system 122. The external computing system 122 includes any type of computing system (e.g., workstation computer, server, laptop computer, SoC computing system, etc.) configured to receive and/or process radar data collected by the radar system 102. For example, the example computing system 122 may be implemented by any combination of hardware, software, and/or firmware (e.g., processors, memories, etc.). In the illustrated example of FIG. 1, the external computing system 122 includes an example object localization and classification processing resource 126. The object localization and classification processing resource 126 may include any combination of processors (e.g., DSPs, general purpose processors, etc.) that process the radar data received from the radar system 102 to localize, classify, and/or otherwise determine information about an object (not shown) detected by the radar system 102. In some examples, the external computing system 122 may perform various actions based on the radar data from the radar system 102. For example, in a building security system context, the external computing system 122 may trigger an emergency process (e.g., alert a security employee) if the radar data indicates that a person has entered an area of the building without authorization. As another example, in a vehicle system, the external computing system may perform a driving maneuver to avoid a potential collision with an obstacle (e.g., other vehicle, pedestrian, etc.) detected by the radar system 102.

In the illustrated example of FIG. 1, the example external computing system 122 is in communication with the radar system 102 via the example network 124. The network 124 may include any type of wired or wireless network (e.g., the Internet) that transports radar data from the radar system 102 (e.g., via the interface resource 144) to the external computing system 122 and/or transports data from the external computing system 122 (e.g., configuration parameters, scan mode settings, instructions, etc.) to the radar system 102. In alternative examples, although not shown in the illustrated example of FIG. 1, the external computing system 122 is alternatively in communication with the radar system 102 directly (e.g., via chip pins, wires, SPI bus, etc.) without using the network 124.

In the illustrated example of FIG. 1, the radar system 102 is in communication with the user interface 128. For example, the user interface 128 may be implemented by a graphical user interface (GUI), an application display, etc., which may be presented to a user on one or more display devices in circuit with and/or otherwise in communication with the radar system 102. In such examples, a user (e.g., a customer, a developer, a technician, a system operator, a building security system employee, etc.) controls the radar system 102 via the user interface 128. For example, the user can use the user interface 128 to instruct the radar system 102 to scan the environment 100 using a particular scan mode at a particular time of day. As another example, the user can use the user interface 128 to adjust a modulation configuration of the transmitted pattern of chirps 132 (e.g., frequency bandwidth, frequency ramp slope, number of chirps, etc.). In alternative examples, the radar system 102 and/or the external computing system 122 alternatively includes and/or otherwise implement the user interface 128.

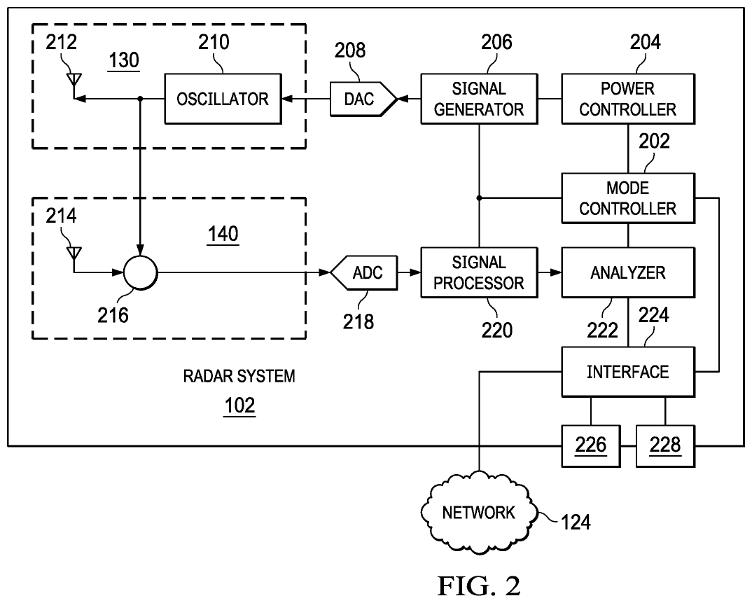

FIG. 2 illustrates an example implementation of the example radar system 102 of FIG. 1. In the illustrated example of FIG. 2, the example radar system 102 includes an example mode controller 202, an example power controller 204, an example signal generator 206, an example digital to analog converter (DAC) 208, an example oscillator 210, an example transmit antenna 212, an example receive antenna 214, an example mixer 216, an example analog to digital converter (ADC) 218, an example signal processor 220, an example analyzer 222, an example interface 224, and example terminals 226 and 228. In some examples, one or more of the example mode controller 202, the example power controller 204, the example signal generator 206, the example DAC 208, the example ADC 218, the example signal processor 220, and/or the example analyzer 222 are implemented by one or more of the example CPU 106, the example hardware accelerators 108, 110, the example general purpose processing resource 112, the example bus 116, and/or the example datastore 120 of FIG. 1.

The mode controller 202 controls a scan mode of the radar system 102. Each scan mode may be associated with a different power and/or computing cost. In a first example scan mode (e.g., low power mode, semi-idle mode, etc.), the mode controller 202 causes the radar system 102 to transmit a pattern of chirps that includes a first block of chirps and a second block of chirps separated by a sleep time period. During the sleep time period, the radar system 102 may operate according to a sleep state in which power consumption by the radar system 102 is reduced (e.g., by reducing power to the transmitter 130, the receiver 140, the analyzer 222, the interface 224, etc.). In a second example scan mode (e.g., active motion detection mode, etc.), the mode controller 202 causes the radar system 102 to perform additional functions that may require more power than the first example mode. For example, in the second example mode, the radar system 102 may attempt to localize a detected object (e.g., estimate an angle of the object relative to radar system 102), and/or transmit radar data to an external system (e.g., the external computing system 122 of FIG. 1) via the interface 224.

The power controller 204 controls a power state of the radar system 102. By way of example, the power controller 204 may transition the power state into a sleep state to reduce power consumption by the radar system 102, or out of the sleep state to allow the radar system 102 to transmit/receive chirps and/or process radar data.

The signal generator 206 provides a control signal to drive the transmitter 130. For example, the signal generator 206 may modulate the control signal according to a desired pattern of chirps, modulation frequencies, signal type (e.g., sinusoid, sawtooth, etc.), and/or other configurations.

The DAC 208 converts the digital control signal from the signal generator 206 into an analog signal for driving the transmitter 130. In the illustrated example of FIG. 2, the transmitter 130 includes an oscillator 210 and a transmit antenna 212. The transmitter 130 may include one or more additional components (e.g., amplifiers, filters, etc.) that are omitted from the example of FIG. 2 for convenience in description.

The oscillator 210 is a local oscillator (e.g., phase locked loop (PLL), voltage controlled oscillator (VCO), etc.) that generates a sequence of chirps based on the control signal from the DAC 208. In some examples, the oscillator 210 includes a VCO that generates frequency ramp segments (e.g., up-ramps, down-ramps, etc.), such as a sinusoid signal that has a gradually increasing (or decreasing) frequency over a chirp duration.

The transmit antenna 212 emits radio signals (e.g., chirps) modulated according to an output of the oscillator 210. The chirps emitted by the transmit antenna 212 may be scattered by one or more objects back to the radar system 102. The scattered chirps are detected by the receive antenna 214. In general, the scattered signals received at the receive antenna 214 may include delayed versions of the chirps transmitted by the transmit antenna 212. The transmit and receive antennas 212 and 214 may include any type of antenna.

The mixer 216 mixes receive signals from the receive antenna 214 with transmit signals output by the oscillator 210 to generate intermediate frequency (IF) signals. For example, each emitted chirp and its corresponding reflected chirp(s) may be combined into an IF signal by the mixer 216.

In the illustrated example of FIG. 2, the receiver 140 includes the mixer 216 and the receive antenna 214. In alternative examples, the receiver 140 may include fewer or additional components (e.g., amplifiers, filters, etc.). For example, the receiver 140 may alternatively be configured to output the receive signals detected by the receive antenna 214 without mixing the receive signals into IF signals.

The ADC 218 converts analog signals output from the receiver 140 (e.g., IF signals, etc.) corresponding to the reflected chirps detected by the receive antenna 214 into digital signals. In some examples, the ADC 218 samples each chirp detected by the receiver 140 to generate a set of ADC samples for each chirp.

The signal processor 220 processes the ADC samples collected by the ADC 218. In some examples, the signal processor 220 includes a digital signal processor (DSP) that computes a range FFT based on the ADC samples of a particular chirp. In some examples, the DSP averages the ADC samples of a first block of chirps to generate a first average signal and averages the ADC samples of a second block of chirps to generate a second average signal. The signal processor 220 then coherently subtracts the first average signal from the second average signal to generate a difference signal. The signal processor 220 then performs a range FFT computation on the difference signal. In this way, a single range FFT computation can be used to detect a motion in the environment of the radar system 102 instead of N range FFT computations, where N is the number of detected chirps.

The analyzer 222 analyzes the range FFT data generated by the signal processor 220. In some examples, the analyzer 22 is implemented by a processor (e.g., general purpose processor, etc.) different than the signal processor 220 (e.g., digital signal processor, etc.). In some examples, the analyzer 222 determines that an object is present or a motion is detected based on the range FFT data including a peak (or maximum). In some examples, the analyzer 222 causes the mode controller 202 to adjust a scan mode of the radar system 102 based on the analysis of the range FFT data. For example, if a motion is detected based on the range FFT data, the analyzer 222 may cause the mode controller 202 to operate the radar system 102 in an active motion detection mode in which multiple receivers (not shown) or receive antennae (not shown) are activated to detect a reflected chirp from different physical locations. The analyzer 222 may then estimate an angle-of-arrival of the reflected chirp (e.g., via an angle FFT computation). In some examples, the analyzer 222 may selectively transmit radar data (e.g., range FFT data, angle FFT data, ADC samples, wake signal, etc.) to the interface 224 depending on a scan mode of the radar system 102. For example, if no motion is detected, the analyzer 222 may prevent transmission of the radar data to the external computing system 122 of FIG. 1 via the interface 224 to reduce power consumption. Whereas, if motion is detected, the analyzer 22 may transmit the radar data to the external computing system 122 to facilitate further analysis and/or data processing (e.g., localization, classification, etc.) of the radar data by the external computing system 122.

The interface 224 is similar to the interface resource 114 of FIG. 1. For example, the interface 224 may include any combination of hardware, software, and/or firmware configured to provide radar data to the external computing system 122 of FIG. 1 via the network 124 and/or via the terminals 226, 228, and/or to receive instructions for the radar system 102 from the external computing system 122 (and/or from the user interface 128).

The example terminals 226 and 228 are physical structures that can be used to electrically couple the radar system 102 with another device or system, such as, for example the example external computing system 122 of FIG. 1. More generally, the example terminals 226 and 228 may be implemented by one or more terminals of the radar system 102. In some examples, the one or more terminals of the radar system 102 may be constructed with and/or otherwise be composed of aluminum, copper, etc., or any other conductive material or combination thereof. In some examples, the one or more terminals 226 and 228 may be implemented as pins (e.g., integrated circuit pins, general purpose input output (GPIO) pins, serial peripheral interface (SPI) pins, universal asynchronous receiver-transmitter (UART) pins, etc.). Alternatively, the one or more terminals 226 and 228 may be implemented as legs (e.g., conductive legs), lugs (e.g., conductive lugs), or any other type of electrical contact.

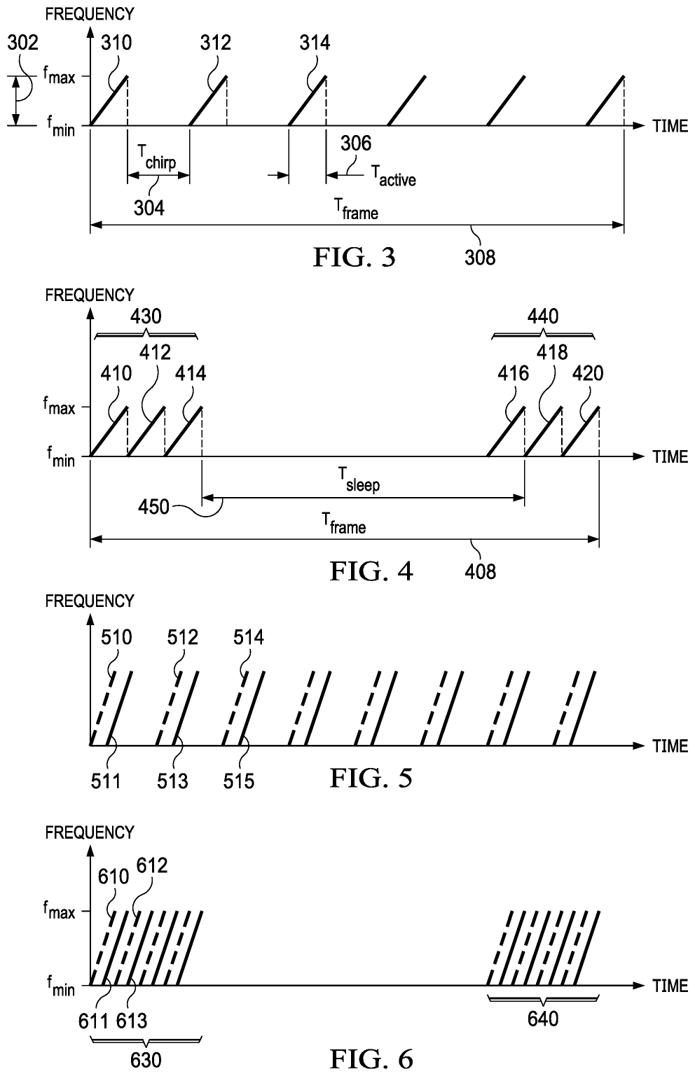

FIG. 3 is a timing diagram of a first example scan pattern representative of a series of chirps evenly distributed across a scan frame transmitted by the example transmitter 130 of FIGS. 1 and 2. By way of example, the first example scan pattern shown in FIG. 3 may correspond to a pattern of chirps transmitted when the radar system 102 is operating in a velocity estimation scan mode. In the illustrated example of FIG. 3, the example oscillator 210 sweeps through a chirp bandwidth 302 (e.g., from fₘᵢₙ to fₘₐₓ) to generate each chirp (e.g., 310, 312, 314, etc.) of the pattern of chirps. In this example, successive chirps are separated in the time domain by an inter-chirp (T_{chirp}) duration 304 (e.g., 30 milliseconds, etc.). The active chirp duration 306 (e.g., 100 microseconds, etc.) of each chirp (T_{active}) represents the duration in which the oscillator 210 ramps the frequency of each chirp across the chirp bandwidth 302 (e.g., from fₘᵢₙ to fₘₐₓ). In the illustrated example of FIG. 3, a pattern of six chirps, including chirps 310, 312, 314, etc., is transmitted during a scan frame time (T_{frame}) period 308 (e.g., 250 milliseconds, etc.).

The range resolution of the radar system 102 may be based on the chirp bandwidth 302. For example, increasing the chirp bandwidth 302 may improve the range resolution. The inter-chirp duration 304 determines the maximum object velocity that the radar system 102 can detect. A total active chirp time (T_{active} total) can be computed as a product of the active chirp duration 306 (e.g., active time per chirp, T_{active}, etc.) and the number of chirps (e.g., six chirps, etc.) in the scan frame time period 308. The total active chirp time is selected based on detection requirements of the radar system 102 (e.g., maximum detection range, etc.). The radar system 102 can determine the velocity resolution or the sensitivity to motion based on the scan frame time period 308.

In some examples, the mode controller 202 of FIG. 2 adjusts the bandwidth 302, the inter-chirp duration 304, the active chirp duration 306, the number of chirps in the scan frame time period 308, and/or the scan frame time period 308 based on the scan mode of the radar system 102.

In some examples, the radar system 102 transitions to a sleep mode during the inter-chirp duration 304 to save power. However, in some examples, transitioning into a sleep mode may cause the radar system 102 to perform a series of operations (e.g., copy logic state(s) of register(s), copy logic state(s) of memory element(s), switching off one or more elements of the analog front end, etc.). In some examples, there may be a series of operations to be performed in response to a transition from a sleep mode (e.g., restoring logic state(s) of register(s), restoring logic state(s) of memory state(s), stabilizing an amplifier and/or a synthesizer of the radar system 102, etc.). In some such examples, entering and exiting a sleep mode may consume more time than the inter-chirp duration 304. For example, in illustrated example of FIG. 3, the multiple times that the radar system 102 may transition into and out of the sleep mode (e.g., between chirps 310, 312, 314, etc.), and the overheads associated with each of these transitions may significantly reduce the power saved by transitioning to a sleep mode. In some examples, the mode controller 202 may operate the radar system 102 in a low power motion detection mode that may reduce the number of times the radar system 102 has to transition into and out of sleep and include a sufficient amount of time (in the sleep period) for the power controller 204 to comfortably transition the radar system 102 into and out of the sleep period. Advantageously, such a reduction in the number of sleep mode transitions may significantly reduce the overhead (e.g., the power consumption overhead) related to transitioning into and out of the sleep mode, which may result in lower power consumption. FIG. 4 may represent a timing diagram for such a low power detection mode.

FIG. 4 is a timing diagram of a second example scan pattern representative of two blocks of chirps transmitted by the example transmitter of FIGS. 1 and 2 in an example low power motion detection mode. In the illustrated example of FIG. 4, the radar system 102 transmits a pattern of chirps including example chirps 410, 412, 414, 416, 418, and 420. For example, the oscillator 210 of FIG. 2 modulates the pattern of chirps transmitted by the transmitter 130 to include a first block of chirps 410, 412, 414 transmitted during a first time period 430 and a second block of chirps 416, 418, 420 transmitted during a second time period 440. The first block of chirps 410, 412, 414 and the second block of chirps are separated (in the time domain) by a sleep time period 450 (Tₛₗₑₑₚ). In some examples, the sleep time period 450 may be sufficient for the radar system 102 to enter and exit the sleep mode with the time associated with the transition overheads representing only a small portion of the total sleep time period 450. For example, during the sleep time period 450, the power controller 204 may transition the radar system 102 into the sleep mode, stay in the sleep mode for a significant amount of time, and then transition out of the sleep mode prior to a start of the second time period 440.

In some examples, the scan frame time period 408 and the number of chirps 410, 412, 414, 416, 418, 420 may be similar to or same as, respectively, the scan frame time period 308 and the number of chirps (six) of FIG. 3. Further, in these examples, a chirp bandwidth and active time per chirp in the chirp pattern of FIG. 4 may be similar to or same as those of FIG. 3. In this way, the pattern of chirps in the example of FIG. 4 may provide the same or similar amount of radiated energy into the environment as that of the pattern of chirps in FIG. 3. Since the same scan frame time period 308, 408 may be used in FIGS. 3 and 4, the pattern of chirps in the example in FIG. 4 may deliver the same sensitivity to motion as the pattern of chirps in the example in FIG. 3. Likewise, the same chirp bandwidth in FIGS. 3 and 4 may imply the same range resolution in FIGS. 3 and 4. However, in the illustrated example of FIG. 3, the sleep time period 450 may allow the radar system 102 to enter the sleep mode between an end of the first time period 430 of the first block of chirps 410, 412, 414 and the second time period 440 of the second block of chirps 416, 418, 420. To facilitate this, in the illustrated example of FIG. 4, the radar system 102 may reduce (and/or eliminate) the inter-chirp duration between successive chirps in each of the first and second blocks of chirps. For example, the first block of chirps 410, 412, 414 may be a plurality of consecutive chirps such that chirp 410 ends at a substantially same time as a beginning of the chirp 412 (or after passage of a minimum amount of time needed for the oscillator 210 to physically transition from fₘₐₓ to fₘᵢₙ), and so on.

FIG. 5 is a timing diagram of a third example scan pattern representative of a series of chirps 510, 511, 512, 513, 514, 515 distributed (e.g., evenly distributed) across a scan frame. In this example, the scan pattern is conceptually similar to the illustrated example of FIG. 3, except that there are two active transmit antennas in the illustrated example of FIG. 4, with the transmitted signal alternating between the two transmit antennas. In this example, first chirps 510, 512, 514 may correspond to chirps emanating from a first transmit antenna and second chirps 511, 513, 515 may correspond to chirps emanating from a second transmit antenna.

FIG. 6 is a timing diagram of a fourth example scan pattern representative of two blocks of chirps 630, 640 including a first block 630 and a second block 640 transmitted by a radar system with two transmit antennas. In this example, the scan pattern is conceptually similar to the illustrated example of FIG. 4, except that there are two active transmit antennas in the illustrated example of FIG. 6, with the transmitted signal alternating between the two transmit antennas. In this example, first ones 610, 612 of the first block 630 may correspond to chirps emanating from a first transmit antenna and second ones 611, 613 of the first block 630 may correspond to chirps emanating from a second transmit antenna. The transmissions of the chirps in the second block 640 may similarly alternate between the two transmit antennas.

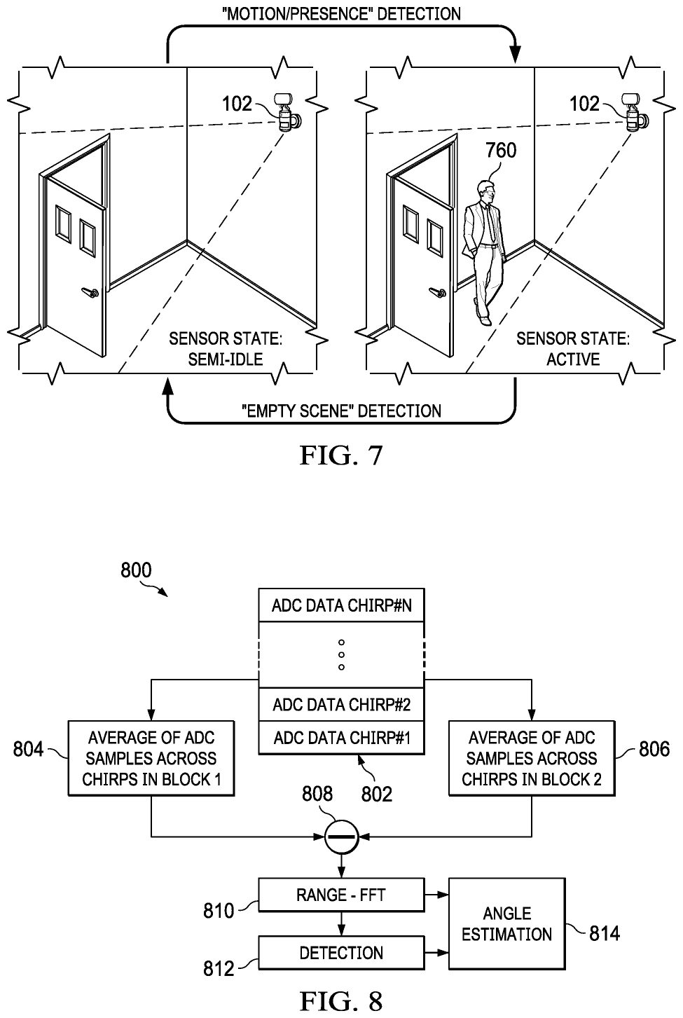

FIG. 7 illustrates a motion detection scenario in which the example radar system 102 of FIGS. 1-2 transitions between a first scan mode and a second scan mode. In the illustrated example of FIG. 7, the example radar system 102 is used in a building security system. When there are no objects detected in the scene, the radar system 102 operates according to a first scan mode (e.g., semi-idle mode), in which the radar system 102 may reduce power consumption by transmitting a pattern of chirps such as the pattern of FIG. 4, and performing minimal data processing operations. For example, the analyzer 222 of FIG. 2 may perform a range FFT computation to determine if a motion is detected but without performing an angle FFT computation and without transmitting radar data to the external computing system 122 via the interface 224.

When a moving object is detected (e.g., object 760), then the radar system 102 transitions to a second scan mode (e.g., active motion detection mode), in which the radar system 102 may perform additional processes requiring additional power consumption. For example, in the second scan mode, the radar system 102 may activate additional receivers and/or additional antenna to attempt to localize the position of the object 760. In the second scan mode (“active”), the analyzer 202 may also perform additional computations (e.g., angle FFT) and the interface 224 may transmit data (e.g., wake up signal, radar data, etc.) to the external computing system 122.

FIG. 8 is a block diagram representative of data processing flow in accordance with an example implementation of the example radar system 102 of FIGS. 1-2.

At block 802, the ADC 218 of FIG. 2 collects ADC samples for each received chirp indicated by the receiver 140. In one example, each set of ADC samples is generated by sampling an IF signal output by mixer 216 for the received signal corresponding to a particular transmit chirp (e.g., chirp 410). The radar system 102 may store the ADC samples for each chirp in a memory (e.g., the datastore 120).

At block 804, the signal processor 220 of FIG. 2 computes an average of ADC samples collected for all the received signals corresponding to all the chirps transmitted (e.g., chirps 410, 412, 414, etc.) in a first block of chirps (e.g., 410, 412, 414). The average of the ADC samples is computed as follows: The average of the first ADC sample of the received signal corresponding to all the transmitted chirps (e.g., 410, 412, 414, etc.) is the first averaged sample. The average of the second ADC sample of the received signal corresponding to all the transmitted chirps (e.g., 410, 412, 414, etc.) is the second averaged sample and so on. Thus, a single average set of ADC samples can be computed for the first block of chirps (e.g., chirps 410, 412, 414). Similarly, at block 806, the signal processor 220 computes an average of ADC samples collected for the corresponding received signals in a second block of chirps (e.g., chirps 416, 418, 420). At block 808, the signal processor 220 coherently subtracts the average signals (i.e., the average ADC samples) of the first block and the second block to generate a difference signal. For example, block 808 may be implemented by a signal mixer or may be implemented by any other type of processor or circuit configuration. At block 810, the signal processor 220 determines a range FFT on the difference signal. For example, the range FFT may transform the difference signal from a time domain to a frequency domain.

At block 812, the analyzer 222 analyzes the range FFT data computed by the signal processor 220 at block 810 to determine if a motion was detected in the scanned environment of the radar system 102. In general, a motion may be detected if the analyzer 222 finds a peak in the range FFT data indicating a motion at a given distance from the radar system 102. Alternatively, motion may also be detected if the analyzer 222 finds the signal level in any of the bins of the range FFT to be above the pre-programmed threshold. At block 814, the analyzer 222 may optionally perform an angle estimation (i.e., localization) computation (e.g., angle FFT) to estimate an angle of arrival of received chirps corresponding to the moving object (e.g., object 760).

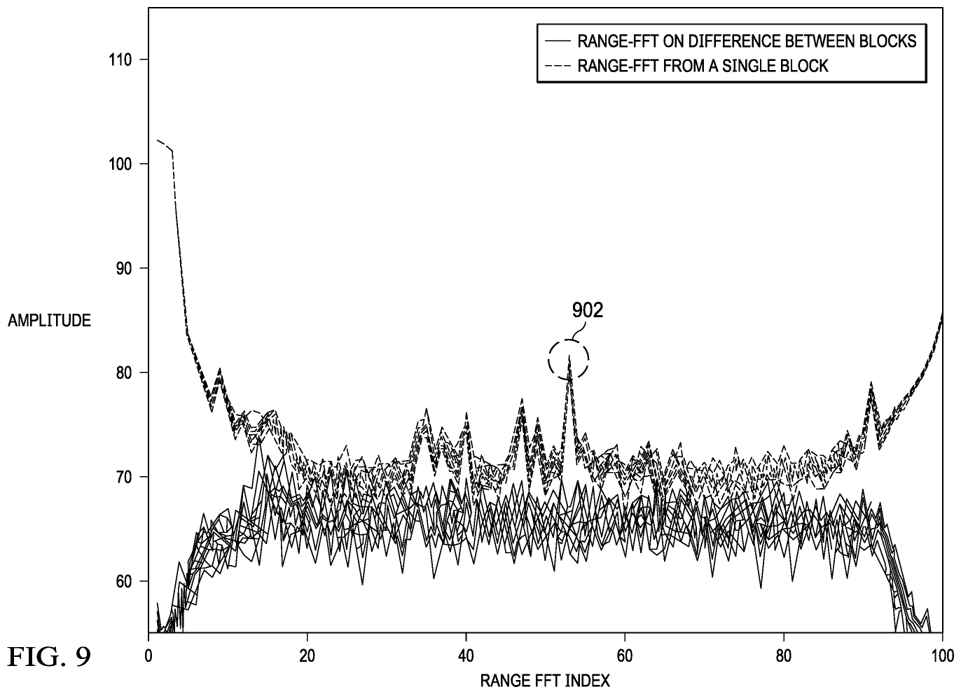

FIG. 9 illustrates range FFT data obtained using the example signal processor 220 and the example analyzer 222 of the example radar system 102 of FIG. 2 in a scenario where the example radar system is scanning a field-of-view that corresponds to an empty scene. For purposes of illustration, the range FFT data represented in FIG. 9 is obtained without averaging the ADC samples of each block (i.e., the averaging described at blocks 804 and 806 of FIG. 8). The horizontal axis in FIG. 9 represents a range FFT index (e.g., normalized frequency components of the range FFT), and the vertical axis represents an amplitude of the frequency components computed in the range FFT. In the illustrated example of FIG. 9, the range FFT data is based on a scenario where the radar system 102 is scanning an “empty scene” (e.g., a scene with no moving objects). In this example, a range FFT computation on the single block of chirps may show local maxima, such as example maximum 902 which may indicate a reflected chirp from a stationary object in the empty scene. On the other hand, the range FFT computations on the difference between two blocks (e.g., blocks 630 and 640) shows very low energy amplitudes across all the range FFT index values.

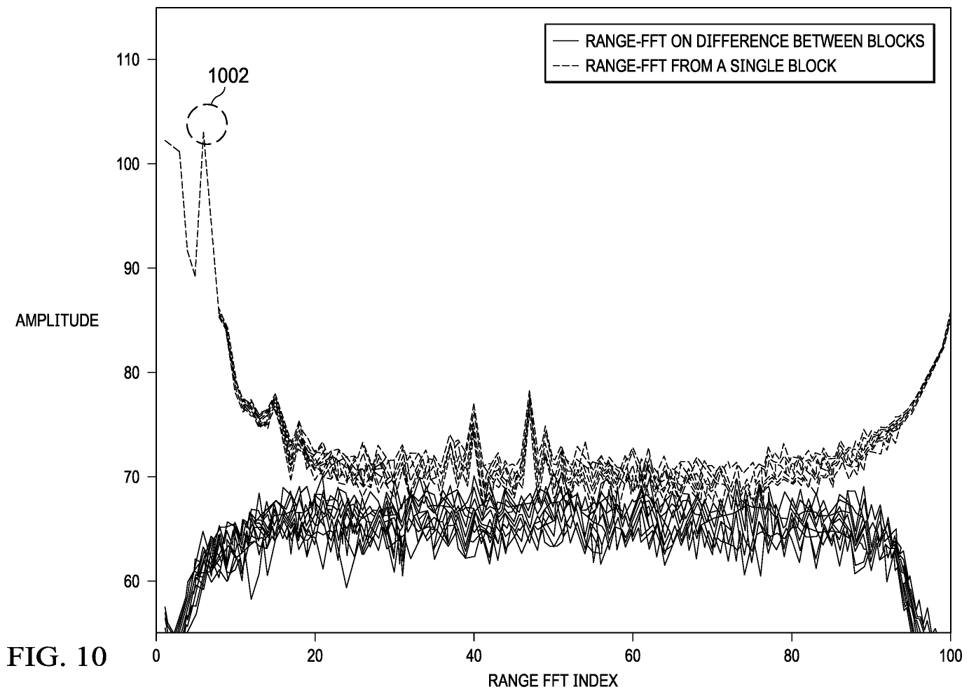

FIG. 10 illustrates range FFT data obtained using the example signal processor 220 and the example analyzer 222 of the example radar system 102 in a scenario where the example radar system is scanning an obstruction (e.g., wall, etc.) in the field-of-view. In the illustrated example of FIG. 10, the range FFT data on the single block of chirps (e.g., block 630) shows an example local maximum 1002 of a high energy frequency component representative of a wall or other obstruction. On the other hand, the range FFT data on the difference between the two blocks of chirps (e.g., blocks 630 and 640) shows very low energy at all the frequency components despite the strong reflection from the wall or other obstruction.

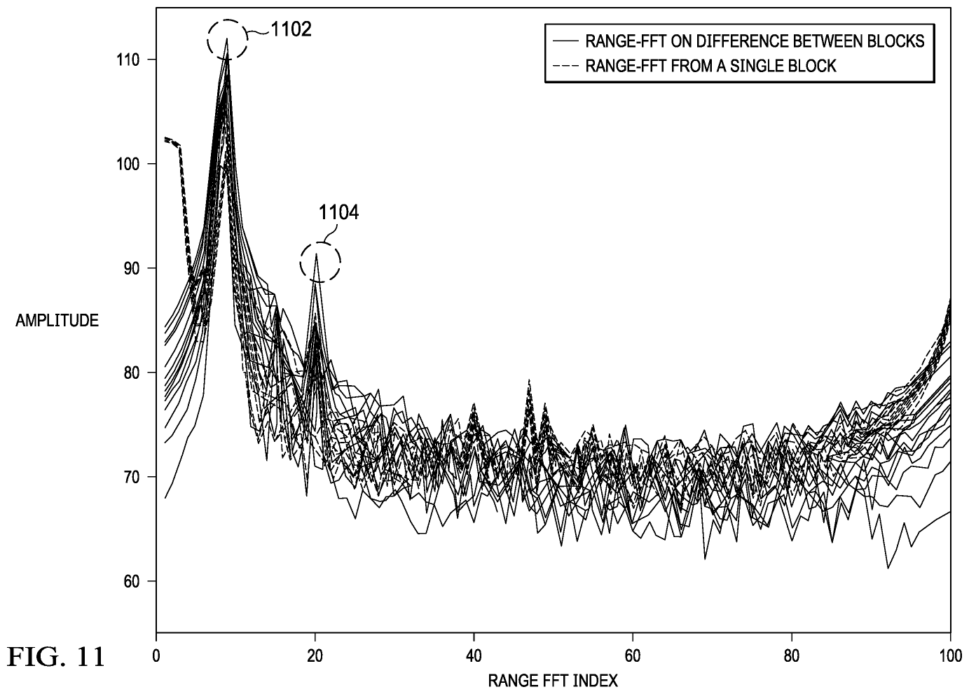

FIG. 11 illustrates range FFT data obtained using the example signal processor 220 and the example analyzer 222 of the example radar system 102 in a scenario where the example radar system scans an object (e.g., object 760) in the field-of-view. In the illustrated example of FIG. 11, the range FFT data on the difference between two blocks of chirps (e.g., blocks 630 and 640) shows two example local maxima 1102 and 1104 representative of micromotions on the body of the “person” or other moving object (e.g., object 760) detected by the radar system 102. In this example the object 760 is standing still, so the peaks (e.g., 1102, 1104 of FIG. 11) may indicate that the technique described in FIG. 8 is sensitive to the micro-motions (e.g., breathing, etc.) of a still person. Thus, the radar system 102 may provide a high level of sensitivity for motion detection even when operating in a low power scan mode. Further, although the illustrated example of FIG. 11 includes separate range FFT data for each pair of chirps in blocks 630 and 640, in some examples, a single range FFT computation can be performed by averaging the ADC samples of all the chirps in a first block (e.g., 630) and averaging the ADC samples of all the chirps in a second block (e.g., 640) separated by a sleep time period (e.g., sleep period 650), in line with the discussion in the description of blocks 804 and 806 of FIG. 8.

While an example manner of implementing the example radar system 102 is illustrated in FIGS. 1-2, one or more of the elements, processes and/or devices illustrated in FIGS. 1-2 may be combined, divided, re-arranged, omitted, eliminated and/or implemented in any other way. Further, the example transmitter 130, the example receiver 140, the example mode controller 202, the example power controller 204, the example signal generator 206, the example DAC 208, the example ADC 218, the example signal processor 220, the example analyzer 222, and/or the example interface 224, and/or, more generally, the example radar system 102 of FIG. 2 may be implemented by hardware, software, firmware and/or any combination of hardware, software and/or firmware. Thus, for example, any of the example transmitter 130, the example receiver 140, the example mode controller 202, the example power controller 204, the example signal generator 206, the example DAC 208, the example ADC 218, the example signal processor 220, the example analyzer 222, and/or the example interface 224, and/or, more generally, the example radar system 102 could be implemented by one or more analog or digital circuit(s), logic circuits, programmable processor(s), programmable controller(s), GPU(s), DSP(s), ASIC(s), PLD(s), and/or FPLD(s). When reading any of the apparatus or system claims of this patent to cover a purely software and/or firmware implementation, at least one of the example transmitter 130, the example receiver 140, the example mode controller 202, the example power controller 204, the example signal generator 206, the example DAC 208, the example ADC 218, the example signal processor 220, the example analyzer 222, and/or the example interface 224 is/are hereby expressly defined to include a non-transitory computer readable storage device or storage disk such as a memory, a DVD, a CD, a Blu-ray disk, etc. including the software and/or firmware. Further still, the example radar system 102 of FIGS. 1-2 may include one or more elements, processes and/or devices in addition to, or instead of, those illustrated in FIGS. 1-2, and/or may include more than one of any or all of the illustrated elements, processes, and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

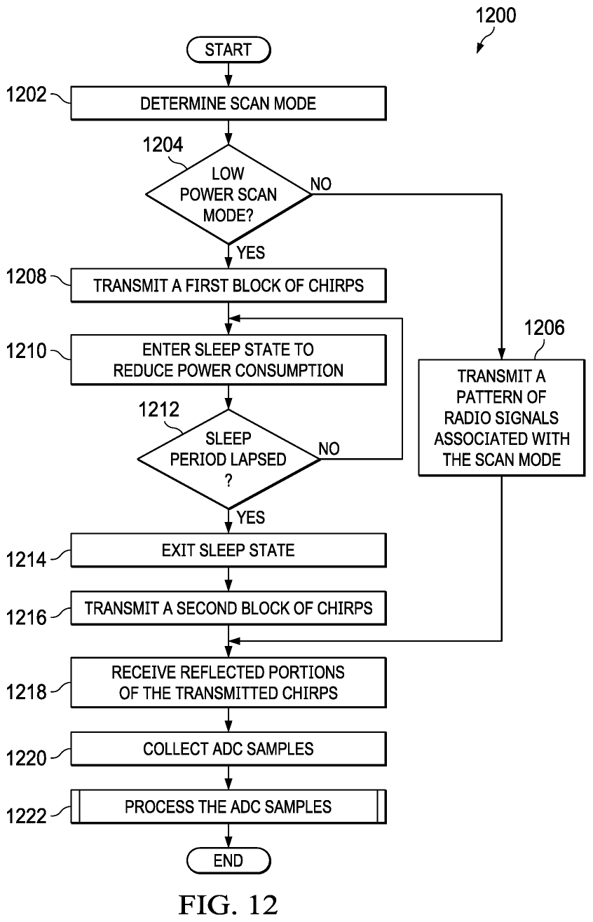

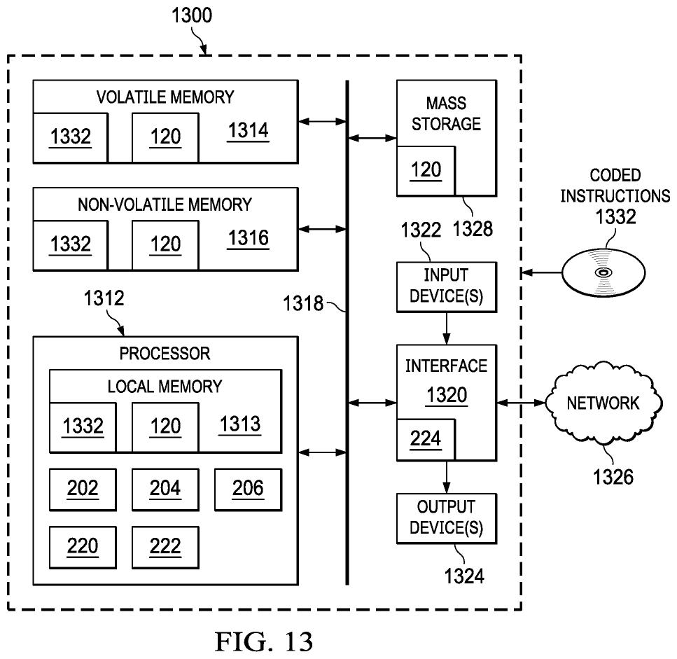

A flowchart representative of example processes, hardware logic, machine readable instructions, hardware implemented state machines, and/or any combination thereof for implementing the example transmitter 130, the example receiver 140, the example mode controller 202, the example power controller 204, the example signal generator 206, the example DAC 208, the example ADC 218, the example signal processor 220, the example analyzer 222, and/or the example interface 224, and/or, more generally, the example radar system 102 of FIG. 2 is shown in FIG. 12. The processes and/or machine readable instructions may be one or more executable programs or portion(s) of an executable program for execution by a computer processor and/or processor circuitry, such as the processor 1312 shown in the example processor platform 1300 discussed below in connection with FIG. 13. The program may be embodied in software stored on a non-transitory computer readable storage medium such as a CD-ROM, a floppy disk, a hard drive, a DVD, a Blu-ray disk, or a memory associated with the processor 1312, but the entire program and/or parts thereof could alternatively be executed by a device other than the processor 1312 and/or embodied in firmware or dedicated hardware. Further, although the example program is described with reference to the flowchart illustrated in FIG. 12, many other methods of implementing the example transmitter 130, the example receiver 140, the example mode controller 202, the example power controller 204, the example signal generator 206, the example DAC 208, the example ADC 218, the example signal processor 220, the example analyzer 222, and/or the example interface 224, and/or, more generally, the example radar system 102 of FIG. 2 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement one or more functions that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example process of FIG. 12 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a,” “an,” “first,” “second,” etc.) do not exclude a plurality. The term “a” or “an” entity, as used herein, refers to one or more of that entity. The terms “a” (or “an”), “one or more,” and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIG. 12 is a flowchart representative of an example process 1200 performed using hardware and/or executable machine readable instructions to implement the example radar system 102 of FIGS. 1-2 or a portion thereof.

The process 1200 begins at block 1202, at which the example mode controller 202 determines a scan mode for operating the example radar system 102. For example, if a moving object (e.g., object 760) is present in the field-of-view of the radar system 102, then the example mode controller 202 determines an active scan mode associated with additional processes and/or functionalities of the radar system 102 that require additional power consumption. Whereas, if there is no moving object is detected, then the mode controller 202 determines a low power scan mode or other suitable scan mode for reducing an average power consumption of the radar system 102. At block 1204, if the mode controller 202 determines that a low power scan mode is detected (e.g., no moving object was detected in the field-of-view), then process 1200 proceeds to block 1208. Otherwise, process 1200 proceeds to block 1206.

At block 1206, the transmitter 130 transmits a pattern of chirps associated with the scan mode determined at block 1202 (e.g., the pattern of FIG. 3, etc.), and then the process 1200 proceeds to block 1218.

At block 1208, the transmitter 130 transmits a first block of chirps (e.g., the first series of chirps 410, 412, 414 of FIG. 4) during a first time period (e.g., time period 430). Then, at block 1210, the power controller 204 transitions a power state of the radar system 102 into a sleep state to reduce power consumption by the radar system 102. As part of the transition of the sleep state, the power controller 204 may reduce power provided to one or more components of the radar system 102 (e.g., the transmitter 130, the receiver 140, the analyzer 222, etc.) and/or may copy a hardware state (e.g., register values, etc.) into a memory of the radar system 102 (e.g., the datastore 120). At block 1212, the power controller 204 determines of a sleep time period has lapsed. If the sleep time period has passed, then the process 1200 proceeds to block 1214. Otherwise, the process 1200 returns to block 1210 and the radar system 102 remains in the sleep state.

At block 1214, the power controller 204 transitions the power state of the radar system 102 out of the sleep state. For example, the power controller 204 may activate (e.g., provide power to) one or more components (e.g., the transmitter 130, the receiver 140, the signal processor 220, the analyzer 222, etc.) as part of the transition out of the sleep state.

At block 1216, the transmitter 130 transmits a second block of chirps (e.g., the second series of chirps 416, 418, 420) during a second time period (e.g., time period 440) after the sleep time period (e.g., sleep time period 450).

At block 1218, the receiver 140 receives reflected chirps corresponding to reflected portions of the transmitted chirps at blocks 1208 and 1216.

At block 1220, the ADC 218 collects ADC samples for each of the received chirps of block 1218. For example, the collected ADC samples may be similar to the collected ADC samples described in connection with block 802 of FIG. 8.

At block 1222, the signal processor 220 (and/or the analyzer 222) process the collected ADC samples of the first block of chirps and the second block of chirps coherently, in line with the discussion in the description of FIG. 8.

FIG. 13 is a block diagram of an example processor platform 1300 structured to execute the instructions of FIG. 12 to implement the example transmitter 130, the example receiver 140, the example mode controller 202, the example power controller 204, the example signal generator 206, the example DAC 208, the example ADC 218, the example signal processor 220, the example analyzer 222, and/or the example interface 224, and/or, more generally, the example radar system 102 of FIGS. 1-2. The processor platform 1300 can be, for example, an electronic control unit of a vehicle, a server, a personal computer, a workstation, a self-learning machine (e.g., a neural network), a gaming console, or any other type of computing device.

The processor platform 1300 of the illustrated example includes one or more processors 1312. The processors 1312 of the illustrated example are hardware. For example, the processors 1312 can be implemented by one or more integrated circuits (ICs), logic circuits, microprocessors, GPUs, DSPs, or controllers from any desired family or manufacturer. The hardware processors may be a semiconductor based (e.g., silicon based) device.

The processors 1312 of the illustrated example include a local memory 1313 (e.g., a cache, a volatile memory, a non-volatile memory, etc.). The processors 1312 of the illustrated example are in communication with a main memory including a volatile memory 1314 and a non-volatile memory 1316 via a bus 1318. The volatile memory 1314 may be implemented by one or more flip-flops, Synchronous Dynamic Random Access Memory (SDRAM), Dynamic Random Access Memory (DRAM), RAIVIBUS® Dynamic Random Access Memory (RDRAM®) and/or any other type of random access memory device. The non-volatile memory 1316 may be implemented by flash memory and/or any other desired type of memory device. Access to the main memory 1314, 1316 is controlled by a memory controller. In the illustrated example, the processors 1312 implement the example mode controller 202, the example power controller 204, the example signal generator 206, the example signal processor 220, and/or the example analyzer 222 of FIG. 2.

The processor platform 1300 of the illustrated example also includes an interface circuit 1320. The interface circuit 1320 may be implemented by any type of interface standard, such as an Ethernet interface, a universal serial bus (USB), a Bluetooth® interface, a near field communication (NFC) interface, and/or a PCI express interface. In the illustrated example, the interface circuit 1320 implements the example interface 224 of FIG. 2.

In the illustrated example, one or more input devices 1322 are connected to the interface circuit 1320. The input device(s) 1322 permit(s) a user to enter data and/or commands into the processors 1312. The input device(s) can be implemented by, for example, an audio sensor, a microphone, a camera (still or video), a keyboard, a button, a mouse, a touchscreen, a track-pad, a trackball, an isopoint device, and/or a voice recognition system.

One or more output devices 1324 are also connected to the interface circuit 1320 of the illustrated example. The output devices 1324 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer and/or speaker. The interface circuit 1320 of the illustrated example, thus, typically includes a graphics driver card, a graphics driver chip and/or a graphics driver processor.

The interface circuit 1320 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1326. The communication can be via, for example, an Ethernet connection, a digital subscriber line (DSL) connection, a telephone line connection, a coaxial cable system, a satellite system, a line-of-site wireless system, a cellular telephone system, etc.

The processor platform 1300 of the illustrated example also includes one or more mass storage devices 1328 for storing software and/or data. Examples of such mass storage devices 1328 include floppy disk drives, hard drive disks, compact disk drives, Blu-ray disk drives, redundant array of independent disks (RAID) systems, and digital versatile disk (DVD) drives.

The machine executable instructions 1332 of FIG. 12 may be stored in the mass storage device 1328, in the volatile memory 1314, in the non-volatile memory 1316, and/or on a removable non-transitory computer readable storage medium such as a CD or DVD. Further, the example datastore 120 of FIG. 1 may be implemented by the volatile memory 1314, the non-volatile memory 1316, the mass storage device 1328, and/or the local memory 1313.

From the foregoing, it will be appreciated that example methods, apparatus, and articles of manufacture have been disclosed that provide for a low power motion detection mode by a radar system. The disclosed methods, apparatus, and articles of manufacture described herein improve the efficiency of using a computing device by reducing the power consumption of a radar system during the low power motion detection mode. The disclosed methods, apparatus, and articles of manufacture are accordingly directed to one or more improvement(s) in the functioning of a computer by reducing the amount of computations needed to perform power motion detection using as little as one range FFT computation in some examples for two blocks of multiple chirps.

Example methods, apparatus, systems, and articles of manufacture to protect secure assets are described herein. Further examples and combinations thereof include the following:

Example 1 includes a radar apparatus comprising: a transmitter to transmit a pattern of chirps, the transmitted pattern including a first series of chirps transmitted during a first time period and a second series of chirps transmitted during a second time period that begins after passage of a sleep time period from an end of the first time period; a receiver to detect returning chirps including reflected portions of the transmitted pattern; and an analog to digital converter (ADC) coupled to the receiver, the ADC to sample analog signals from the receiver to generate ADC samples for the returning chirps detected by the receiver.

Example 2 includes the radar apparatus of example 1, wherein the sleep time period is greater than the first time period.

Example 3 includes the radar apparatus of example 1, wherein the sleep time period is greater than an inter-chirp duration between successive chirps of the first series of chirps.

Example 4 includes the radar apparatus of example 1, wherein the first series of chirps includes a same number of chirps as the second series of chirps.

Example 5 includes the radar apparatus of example 1, wherein each chirp of the first series of chirps has a same frequency ramp slope, and wherein each chirp of the second series of chirps has the same frequency ramp slope.

Example 6 includes the radar apparatus of example 1, wherein an inter-chirp duration between successive chirps of the first series of chirps is less than 10 microseconds, wherein the sleep time period is greater than 100 milliseconds, and wherein the transmitter is to transmit the pattern of chirps during a scan frame period that is less than or equal to 250 milliseconds.

Example 7 includes the radar apparatus of example 1, wherein the first series of chirps is a first plurality of consecutive chirps, and wherein the second series of chirps is a second plurality of consecutive chirps.

Example 8 includes the radar apparatus of example 1, further comprising: a power controller to control a power state of the radar apparatus, the power controller to transition the power state into a sleep state after the end of the first time period, wherein the transition into the sleep state reduces power consumption by the radar apparatus.

Example 9 includes the radar apparatus of example 8, wherein the power controller is to transition the power state out of the sleep state prior to a start of the second time period, wherein the transition out of the sleep state increases power consumption by the radar apparatus.

Example 10 includes the radar apparatus of example 1, further comprising: a signal processor coupled to the ADC, the signal processor to coherently process first ADC samples associated with the first series of chirps and second ADC samples associated with the second series of chirps.

Example 11 includes the radar apparatus of example 10, wherein the signal processor is to determine a first average of the first ADC samples associated with the first series of chirps and a second average of the second ADC samples associated with the second series of chirps.

Example 12 includes the radar apparatus of example 11, wherein the signal processor is to subtract the first average and the second average to generate a difference signal, and wherein the signal processor is to perform a range fast Fourier transform (FFT) on the difference signal.

Example 13 includes the radar apparatus of claim 12, further comprising an analyzer to detect motion of an object based on the difference signal.

Example 14 includes the radar apparatus of example 1, wherein the radar apparatus is a System-on-a-Chip (SoC) device.

Example 15 includes the radar apparatus of example 1, wherein the radar apparatus is integrated on an integrated circuit (IC) substrate.

Example 16 includes a method comprising: transmitting, at a transmitter of a radar system, a first series of chirps during a first time period; transmitting, after passage of a sleep time period from an end of the first time period, a second series of chirps during a second time period; receiving, at a receiver, reflected chirps including reflected portions of the transmitted first series of chirps and the transmitted second series of chirps; and sampling analog signals from the receiver to generate ADC samples for each of the reflected chirps.

Example 17 includes the method of example 16, wherein the sleep time period is greater than the first time period.

Example 18 includes the method of example 16, wherein the sleep time period is greater than an inter-chirp duration between successive chirps of the first series of chirps.

Example 19 includes the method of example 16, wherein the first series of chirps includes a same number of chirps as the second series of chirps.

Example 20 includes a non-transitory machine readable medium storing instructions that, when executed by one or more processors, cause a radar system to: transmit, at a transmitter of the radar system, a first series of chirps during a first time period; transmit, after passage of a sleep time period from an end of the first time period, a second series of chirps during a second time period; receive, at a receiver of the radar system, reflected chirps including reflected portions of the transmitted first series of chirps and the transmitted second series of chirps; and sample, at an analog to digital converter (ADC) of the radar system, analog signals from the receiver to generate ADC samples for each of the reflected chirps.

Example 21 includes the non-transitory machine readable medium of example 20, wherein each chirp of the first series of chirps has a same frequency ramp slope, and wherein each chirp of the second series of chirps has the same frequency ramp slope.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

What is claimed is:

1. A radar apparatus comprising:
a transmitter to transmit a pattern of chirps, the transmitted pattern including a first series of chirps transmitted during a first time period and a second series of chirps transmitted during a second time period that begins after passage of a sleep time period from an end of the first time period;
a receiver to detect returning chirps including reflected portions of the transmitted pattern; and
an analog to digital converter (ADC) coupled to the receiver, the ADC to sample analog signals from the receiver to generate ADC samples for the returning chirps detected by the receiver.

2. The radar apparatus of claim 1, wherein the sleep time period is greater than the first time period.

3. The radar apparatus of claim 1, wherein the sleep time period is greater than an inter-chirp duration between successive chirps of the first series of chirps.

4. The radar apparatus of claim 1, wherein the first series of chirps includes a same number of chirps as the second series of chirps.

5. The radar apparatus of claim 1, wherein each chirp of the first series of chirps has a same frequency ramp slope, and wherein each chirp of the second series of chirps has the same frequency ramp slope.

6. The radar apparatus of claim 1, wherein an inter-chirp duration between successive chirps of the first series of chirps is less than 10 microseconds, wherein the sleep time period is greater than 100 milliseconds, and wherein the transmitter is to transmit the pattern of chirps during a scan frame period that is less than or equal to 250 milliseconds.

7. The radar apparatus of claim 1, wherein the first series of chirps is a first plurality of consecutive chirps, and wherein the second series of chirps is a second plurality of consecutive chirps.

8. The radar apparatus of claim 1, further comprising:
a power controller to control a power state of the radar apparatus, the power controller to transition the power state into a sleep state after the end of the first time period, wherein the transition into the sleep state reduces power consumption by the radar apparatus.

9. The radar apparatus of claim 8, wherein the power controller is to transition the power state out of the sleep state prior to a start of the second time period, wherein the transition out of the sleep state increases power consumption by the radar apparatus.

10. The radar apparatus of claim 1, further comprising:
a signal processor coupled to the ADC, the signal processor to coherently process first ADC samples associated with the first series of chirps and second ADC samples associated with the second series of chirps.

11. The radar apparatus of claim 10, wherein the signal processor is to determine a first average of the first ADC samples associated with the first series of chirps and a second average of the second ADC samples associated with the second series of chirps.

12. The radar apparatus of claim 11, wherein the signal processor is to subtract the first average and the second average to generate a difference signal, and wherein the signal processor is to perform a range fast Fourier transform (FFT) on the difference signal.

13. The radar apparatus of claim 12, further comprising an analyzer to detect motion of an object based on the difference signal.

14. The radar apparatus of claim 1, wherein the radar apparatus is a System-on-a-Chip (SoC) device.

15. The radar apparatus of claim 1, wherein the radar apparatus is integrated on an integrated circuit (IC) substrate.

16. A method comprising:
transmitting, at a transmitter of a radar system, a first series of chirps during a first time period;
transmitting, after passage of a sleep time period from an end of the first time period, a second series of chirps during a second time period;
receiving, at a receiver, reflected chirps including reflected portions of the transmitted first series of chirps and the transmitted second series of chirps; and
sampling analog signals from the receiver to generate ADC samples for each of the reflected chirps.

17. The method of claim 16, wherein the sleep time period is greater than the first time period.

18. The method of claim 16, wherein the sleep time period is greater than an inter-chirp duration between successive chirps of the first series of chirps.

19. The method of claim 16, wherein the first series of chirps includes a same number of chirps as the second series of chirps.

20. A non-transitory machine readable medium storing instructions that, when executed by one or more processors, cause a radar system to:
transmit, at a transmitter of the radar system, a first series of chirps during a first time period;
transmit, after passage of a sleep time period from an end of the first time period, a second series of chirps during a second time period;
receive, at a receiver of the radar system, reflected chirps including reflected portions of the transmitted first series of chirps and the transmitted second series of chirps; and
sample, at an analog to digital converter (ADC) of the radar system, analog signals from the receiver to generate ADC samples for each of the reflected chirps.

21. The non-transitory machine readable medium of claim 20, wherein each chirp of the first series of chirps has a same frequency ramp slope, and wherein each chirp of the second series of chirps has the same frequency ramp slope.
